(19) United States
(12) Patent Application Publication
(10) Pub. No.: US 2024/0102801 A1
(43) Pub. Date: Mar. 28, 2024

(54) SURVEYING SYSTEM, SURVEYING METHOD, AND PROGRAM

(71) Applicant: TOPCON CORPORATION, Tokyo (JP)

(72) Inventor: You SASAKI, Tokyo (JP)

(73) Assignee: TOPCON CORPORATION, Tokyo (JP)

(21) Appl. No.: 18/470,558

(22) Filed: Sep. 20, 2023

(30) Foreign Application Priority Data
Sep. 26, 2022 (JP) 2022-152762

(51) Int. Cl. G01C 15/00; G01C 15/06; G01S 19/42; G06N 20/00

(52) U.S. Cl. CPC G01C 15/002; G01C 15/06; G01S 19/42; G06N 20/00

(57) ABSTRACT

Automation of surveying operations is achieved. When surveying is performed by a surveying apparatus, acquisition of a surveying condition, acquisition of surveying data, acquisition of image data, and acquisition of environmental data are performed. These pieces of data are associated with each other and are stored as learning data. On the basis of this learning data, an AI-estimated model for estimating a surveying condition by using image data of a surveying target and environmental data of a surveying site, is generated.

### CROSS-REFERENCE TO RELATED APPLICATIONS

This application claims the benefit of priority under 35 U.S.C. 119 to Japanese Patent Application No. 2022-152762, filed Sep. 26, 2022; the disclosure of which is incorporated herein by reference in their entirety.

### FIELD

The present invention relates to a surveying technique.

### BACKGROUND

Techniques for collecting basic data, such as about road environments by using a laser distance measurement apparatus, are known (for example, refer to Japanese Unexamined Patent Application Publication No. 2021-168144).

### SUMMARY OF THE INVENTION

Surveying using laser light is susceptible to weather and the environment. In order to cope with this drawback, a worker who operates a surveying apparatus performs various settings in accordance with site conditions. In addition, automation of surveying operations is desired in recent years. For the purpose of increasing automation of surveying operations, various settings are required to be automatically performed.

In view of these circumstances, an object of the present invention is to provide a technique for enabling automation of surveying operations.

The present invention provides a surveying system including a surveying apparatus, a camera, and a processor or circuitry. The surveying apparatus is configured to perform surveying. The camera is configured to obtain a photographic image of a surveying target. The processor or circuitry is configured to acquire environmental data of a site at which the surveying is performed and to store a surveying condition that is set in the surveying apparatus, the photographic image of the surveying target, which is obtained by the camera, and the environmental data, in association with each other.

In one aspect of the present invention, the processor or circuitry may be further configured to generate learning data by associating the surveying condition that is set in the surveying apparatus, the photographic image of the surveying target, which is obtained by the camera, and the environmental data, with each other. This processor or circuitry may be further configured to generate an AI-estimated model to be used for estimating a new surveying condition that is set in the surveying apparatus, based on a photographic image of the surveying target and environmental data that are newly obtained.

In one aspect of the present invention, the processor or circuitry may be further configured to generate learning data by associating the surveying condition that is set in the surveying apparatus, the photographic image of the surveying target, which is obtained by the camera, and the environmental data, with each other. This processor or circuitry may be further configured to have an AI-estimated model to be used for estimating a new surveying condition that is set in the surveying apparatus, based on a photographic image of the surveying target and environmental data that are newly obtained.

In one aspect of the present invention, in response to performing surveying by the surveying apparatus, the surveying condition that is set in the surveying apparatus, the photographic image of the surveying target, which is obtained by the camera, and the environmental data, may be stored in association with each other. In one aspect of the present invention, the surveying system may further include a GNSS position measurement device that is configured to perform surveying of a position based on a navigation signal from a GNSS navigation satellite. In this case, at least one piece of the environmental data may be acquired based on position information obtained in surveying by the GNSS position measurement device. In one aspect of the present invention, at least one piece of the environmental data may be acquired based on position information obtained from the surveying target.

In one aspect of the present invention, the surveying system may further include a GNSS position measurement device that is configured to measure a position based on a navigation signal from a GNSS navigation satellite. In this case, the environmental data may contain data of weather at a site at which the surveying is performed, and the data about weather at the site at which the surveying is performed may be acquired from the Internet, based on information of the position measured by the GNSS position measurement device.

In one aspect of the present invention, the processor or circuitry may be further configured to estimate the surveying condition based on the environmental data. In this case, appropriateness of the estimation may be determined based on result of the surveying. In a case in which the estimation is determined as being appropriate, the surveying condition that is set in the surveying apparatus, the photographic image of the surveying target, which is obtained by the camera, and the environmental data, may be stored in association with each other.

The present invention also provides a surveying method including performing surveying by using a surveying apparatus, obtaining a photographic image of a surveying target, acquiring environmental data of a site at which the surveying is performed, and storing a surveying condition that is set in the surveying apparatus in performing the surveying, the obtained photographic image of the surveying target, and the environmental data, in association with each other.

The present invention also provides a non-transitory computer recording medium storing computer executable instructions. The computer executable instructions are made to, when read and executed by a computer processor, cause the computer processor to make a surveying apparatus perform surveying, obtain a photographic image of a surveying target, acquire environmental data of a site at which the surveying is performed, and store a surveying condition that is set in the surveying apparatus in performing the surveying, the obtained photographic image of the surveying target, and the environmental data, in association with each other.

The present invention enables automation of surveying operations.

### BRIEF DESCRIPTION OF DRAWINGS

FIG. 1 shows an external appearance of a total station.

FIG. 2 is a block diagram of the total station.

FIG. 3 is a flowchart showing an example of a processing procedure.

### DETAILED DESCRIPTION

### 1. First Embodiment

### Surveying Apparatus

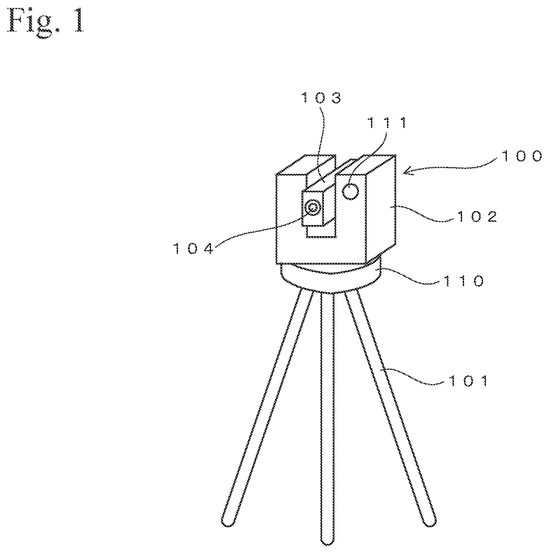

FIG. 1 shows a total station 100 as an example of a surveying apparatus. Examples of the surveying apparatus include a laser scanning apparatus and a theodolite, in addition to a total station.

The total station 100 is supported by a tripod 101. An automatic leveling mechanism 110 (tribrach) is placed on top of the tripod 101. A horizontally rotatable horizontal rotation unit 102 is disposed on top of the automatic leveling mechanism 110. The horizontal rotation unit 102 includes a camera 111 and a vertically rotatable vertical rotation unit 103.

The camera 111 takes still images. A video camera that takes moving images can also be used as the camera 111. The camera 111 takes photographic images of a surveying target.

The vertical rotation unit 103 includes an optical unit 104, which emits distance measuring light to the outside and receives the distance measuring light that is reflected back. The optical unit 104 is also used as an optical system of a telescope for sighting in surveying. The camera 111 and the optical unit 104 are set in such a manner that the directions of the optical axes thereof agree with each other in the state in which the optical unit 104 is directed in a horizontal direction. It is also possible to incorporate a camera in a housing case and perform photographing via the optical unit 104 by using this camera.

The vertical rotation unit 103 also includes an optical system that emits and detects laser light for capturing and tracking a target (e.g., a surveying target, such as a reflection prism). The automatic leveling mechanism 110 makes the horizontal rotation unit 102 level. Details of the automatic leveling mechanism are disclosed in, for example, Japanese Patent No. 6490477.

### Block Diagram

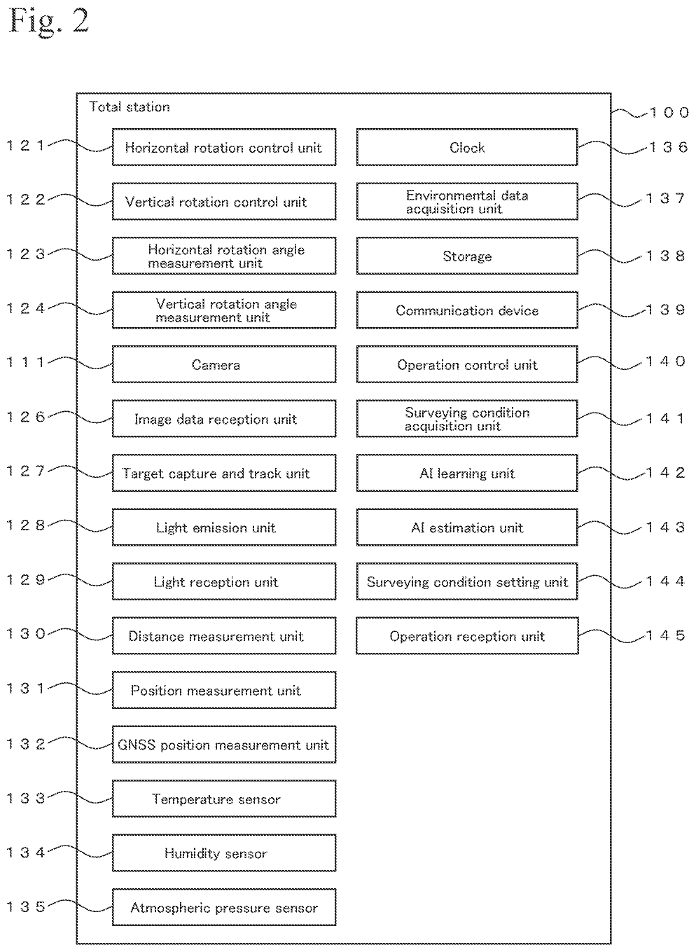

FIG. 2 is a block diagram of the total station 100. A horizontal rotation control unit 121 controls a motor for horizontally rotating the horizontal rotation unit 102. A vertical rotation control unit 122 controls a motor for vertically rotating the vertical rotation unit 103. A horizontal rotation angle measurement unit 123 includes an encoder that measures horizontal rotation of the horizontal rotation unit 102 and also includes peripheral circuits thereof, and it measures a horizontal rotation angle of the horizontal rotation unit 102. A vertical rotation angle measurement unit 124 includes an encoder that measures vertical rotation of the vertical rotation unit 103 and also includes peripheral circuits thereof, and it measures a vertical rotation angle (elevation angle or depression angle) of the vertical rotation unit 103.

The camera 111 is a digital still camera that takes still images. Relationships of exterior orientation parameters between the camera 111 and the optical unit 104 (optical system used for laser surveying) are already known. A camera that takes a moving image can also be used as the camera 111. An image data reception unit 126 receives image data of photographic images obtained by the camera 111.

A target capture and track unit 127 captures and tracks a target (e.g., a surveying target, such as a reflection prism) by using laser light for capturing and tracking, which is emitted from the optical system. Details of this technique are disclosed in, for example, Japanese Patent No. 5124319.

A light emission unit 128 includes a light emitting element, peripheral circuits, and an optical system, and it emits distance measuring light (pulsed laser light) for measuring a distance. A light reception unit 129 includes a light receiving element, peripheral circuits, and an optical system, and it receives distance measuring light that is reflected back from a target and then outputs a light reception signal.

A distance measurement unit 130 calculates a distance from an optical origin of the total station 100 to a reflection point that reflects distance measuring light. In this example, distance measuring light is output from the light emission unit 128 and is split into two beams. One beam is emitted from the optical unit 104 to the outside, whereas the other beam is led to a reference optical path set in the inside of the total station 100. The light reception unit 129 receives distance measuring light that has reflected back from a target and also receives distance measuring light that has propagated through the reference optical path.

The reference optical path is short, and therefore, the other beam of distance measuring light that has propagated through the reference optical is detected first, and the one beam of distance measuring light that has reflected back from a target is then detected. A distance from the optical origin of the total station 100 to a reflection point is calculated from a phase difference between detection signals of the two beams of distance measuring light. The distance can also be calculated by measuring a time-of-flight of distance measuring light.

A position measurement unit 131 calculates a three-dimensional position of a surveying point (a reflection point that reflects distance measuring light). Herein, assuming that the optical origin of the total station 100 is the origin, a three-dimensional position of a surveying point is calculated as data of a distance and a direction from the origin. In this state, in the condition in which exterior orientation parameters (position and attitude) in an absolute coordinate system of the total station 100 are known, coordinates (three-dimensional position) in the absolute coordinate system of a surveying point are obtained.

A global navigation satellite system (GNSS) position measurement device 132 performs surveying of a position by using a navigation signal from a navigation satellite, such as a global positioning system (GPS) satellite. The function of the GNSS position measurement device 132 is the same as that of a general GPS receiver.

A temperature sensor 133 measures air temperature of the environment in which the total station 100 is set up and also measures a temperature inside of the housing case. A humidity sensor 134 measures humidity of the environment in which the total station 100 is set up. An atmospheric pressure sensor 135 measures atmospheric pressure of the environment in which the total station 100 is set up. A clock 136 tracks the date and time.

An environmental data acquisition unit 137 acquires environmental data of a site at which the total station 100 is set up. The environmental data include types of data such as weather (sunny weather, rainy weather, cloudy weather, or foggy weather), air temperature, humidity, atmospheric pressure, elevation, type of landform (flat land, wood, grove, grassland, city area, sand area, river beach, coast, forest, mountain, or mountain stream), and indoor conditions if the total station 100 is set up in an indoor place.

Pieces of data of air temperature, humidity, and atmospheric pressure are measured by the sensors equipped on the total station 100, and the measured values are acquired. Data about weather, elevation, and type of landform are acquired from the Internet. The total station 100, which includes the GNSS position measurement device 132, can obtain information of a set-up position in an absolute coordinate system. The absolute coordinate system is a coordinate system that is used in a map and in a GNSS.

After position information is obtained, data about weather, elevation, and type of landform at the position can be obtained from the Internet.

The environmental data that is acquired by the environmental data acquisition unit 137 is associated with date and time when surveying is performed, a photographic image of a target obtained by the camera 111, and results and conditions of surveying performed by the total station 100. The resultant associated data is stored in a storage 138, as learning data for generating an artificial intelligence (AI)-estimated model, which will be described later.

The storage 138 stores data and a program that are necessary to operate the total station 100, and data obtained as a result of operation. In addition, the storage 138 stores the learning data.

An example of data components stored in the storage 138 is shown in Table 1. In Table 1, image data of a target reflection prism and a surveying condition are associated with each other by a label. In addition to the data shown in Table 1, an intensity of detected distance measuring light, waveform data of a light receiving element, etc., are also stored in association with the label. In a case of surveying a target that moves, time-based variations in surveying result are also stored.

TABLE 1

| Label | Distance | Elevation | Date | Time | Air Temperature | Humidity | Weather |
|---|---|---|---|---|---|---|---|
| Prism A | 50 meters | 150 meters | 2022/6/1 | 16:15 | 27° C. | 80% | Rainy |
| Prism B | 20 meters | 100 meters | 2022/6/1 | 10:34 | 30° C. | 65% | Sunny |

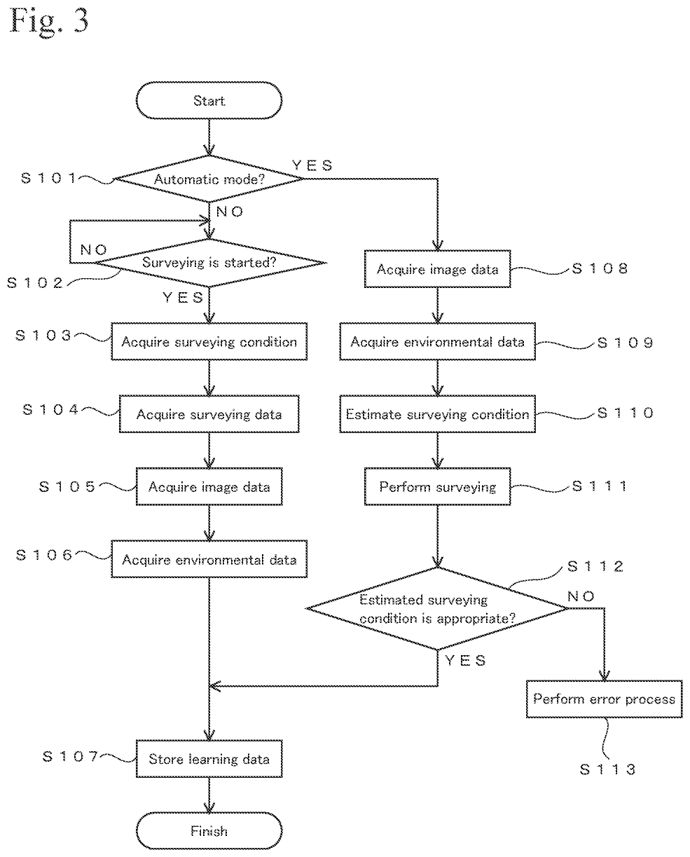

A communication device 139 performs a communication using an Internet line and also performs a communication using a wireless local area network (WLAN). An operation control unit 140 is a computer that controls operation of the total station 100. In one example, the operation control unit 140 executes control of processing in a flow shown in FIG. 3, which will be described later.

A surveying condition acquisition unit 141 acquires a surveying condition of surveying that is performed by the total station 100. Examples of the surveying condition include a condition related to selection of a target, a condition related to the type of a target (e.g., a target is a reflection prism or a target is a part having a certain shape), intensity of distance measuring light in surveying, use or non-use of a light reduction filter, the number of pulses of distance measuring light, the number of targets, and a method for processing data. Moreover, a condition such as a condition for tracking a target is also used as the surveying condition.

For example, in a survey setting point determination operation using the total station 100, the following working processes are repeated: a reflection prism is carried to a position that is specified in a design drawing, and the position is determined by using the reflection prism. In this case, a processing condition related to detection, tracking, and position determination of the reflection prism is used as the surveying condition.

In another example, a position of a construction machine having a reflection prism is measured by a total station, and a trajectory of movement or a blade edge position of the construction machine is obtained in the form of data. In this technique, a processing condition related to detection, tracking, and position determination of the reflection prism is used as the surveying condition.

An AI learning unit 142 performs learning in order to generate an AI-estimated model by using learning data. The learning data is data obtained by associating the environmental data that is acquired by the environmental data acquisition unit 137, date and time when surveying is performed, a photographic image of a target obtained by the camera 111, result of surveying performed by the total station 100, and a surveying condition (surveying condition acquired by the surveying condition acquisition unit 141), with each other. The result of surveying includes, in addition to a measured distance value and data of a measured position, an intensity of detected distance measuring light, and a detected waveform (an output waveform of the light receiving element).

An AI estimation unit 143 estimates a surveying condition by using the AI-estimated model. The AI estimation unit 143 inputs a photographic image from the camera 111 and the environmental data, in the AI-estimated model, and it then estimates a surveying condition. The AI-estimated model is obtained by learning relationships between environmental data, a photographic image, and a surveying condition. Thus, the environmental data and the photographic image are input in the AI-estimated model, whereby an unknown parameter, that is, a surveying condition, is estimated.

A surveying condition setting unit 144 sets the estimated surveying condition in the total station 100. An operation reception unit 145 receives various settings, adjustments, and operations that are performed on the total station 100 by a user (worker). The operation is performed by using a dedicated operation terminal, a smartphone, or an operation panel equipped on the total station 100, which is not shown in FIG. 1.

### Example of Processing

The following describes an example of operation of the total station 100. FIG. 3 is a flowchart showing an example of a processing procedure. The program for executing the processing in FIG. 3 is stored in the storage 138 or an appropriate storage medium and is executed by hardware shown in FIG. 2.

Prior to the processing, an AI-estimated model is generated and is made ready for estimating a surveying condition in the processes in steps S103 to S106, which will be described later.

After the total station 100 is set up at a surveying site, and surveying is started, the processing in FIG. 3 is started. First, it is determined whether a surveying mode is automatic or manual (step S101). The setting for an automatic operation or the setting for a manual operation is selected by a user in advance.

Herein, an automatic surveying mode is a mode for estimating a surveying condition by using the AI-estimated model and then performing automatic or semi-automatic (partially manual) surveying with the use of the total station 100 in accordance with the estimated surveying condition. A manual surveying mode is a mode for performing surveying in accordance with operation to the total station 100 by a worker, in the same manner as in existing techniques.

In the condition in which the surveying mode is not automatic (the surveying mode is manual), the processing advances from step S101 to step S102. In step S102, it is determined whether surveying (e.g., surveying of a position of a target) using the total station 100 has started. After the surveying is started, acquisition of a surveying condition (step S103), acquisition of surveying data (step S104), acquisition of image data (step S105), and acquisition of environmental data (step S106) are performed.

In this case, the surveying condition is a condition for surveying that is performed by the total station 100, which is a determination target in step S102. The surveying condition that is acquired in step S103 is a surveying condition set by a worker who operates the total station 100.

The image data is data of a photographic image obtained by the camera 111, and the photographic image contains an object that is a surveying target. The environmental data is data of weather (sunny weather, rainy weather, cloudy weather, or foggy weather), air temperature, humidity, atmospheric pressure, and elevation. The environmental data may be prepared at the stage when the total station 100 is set up at a surveying site, and this data may be acquired. Alternatively, the environmental data may be acquired by performing an acquisition process at the time the result in step S101 is YES.

After step S106 is performed, the pieces of data that are acquired in steps S103 to S106 are associated with each other and are stored as learning data (step S107). This learning data is used in learning for obtaining an AI-estimated model to be used for estimating a surveying condition in step S110, which will be described later.

In the case in which the surveying mode is determined as being automatic in step S101, the processing advances from step S101 to step S108. Then, image data is acquired (step S108), and environmental data is also acquired (step S109). The image data is image data of a photographic image of a surveying target, and the environmental data is the same as that in step S106.

Next, the pieces of data that are acquired in steps S108 and S109 are input in the AI-estimated model, and a surveying condition corresponding to the pieces of data acquired in steps S108 and S109 is estimated (step S110).

After the surveying condition is estimated, the total station 100 performs surveying (e.g., surveying of a position of a reflection prism) in accordance with the estimated surveying condition (step S111).

Then, on the basis of results of surveying in step S111, whether the surveying condition estimated in step S110 is appropriate is determined (step S112).

The determination of appropriateness of the surveying condition in step S112 is performed as follows. First, the tendency of surveying results is estimated based on the learning data when the surveying condition is estimated. This preliminarily estimated tendency of surveying result is compared with actual result of surveying, and matching therebetween is evaluated. In the case in which matching is found therebetween, the determination in step S112 results in YES. Otherwise, the determination in step S112 results in NO.

In one example in which surveying is performed on a reflection prism that has a high reflection efficiency, a surveying condition such that an emission intensity of distance measuring light is reduced, or a light reduction filter is inserted in the optical path, is adopted so that a detected intensity of distance measuring light will be an appropriate value. Thus, in the case in which a surveying condition for surveying of a reflection prism is estimated, the tendency of an estimated surveying result includes a content related to a value of a detected intensity of distance measuring light that is adjusted. In this situation, the tendency of the estimated surveying result is represented in terms of, for example, a range of a detection level of distance measuring light.

The surveying condition for a reflection prism may not be adopted, although a reflection prism is to be surveyed. In this case, in actual surveying, highly intense light is reflected back from the reflection prism and is detected, and the measured value does not match with the tendency of the estimated surveying result. Thus, the determination in step S112 results in NO.

In another example, surveying may be performed by tracking an unmanned aerial vehicle (UAV) by a total station. In this case, a surveying condition for this surveying may be estimated, and an estimated surveying result includes a tendency of a flight path of the UAV. Under these conditions, whether the tendency of this estimated flight path matches with a flight path of the UAV that is actually surveyed, is determined in step S112.

In yet another example, an amount of driving a prop into a ground may be measured by a total station. In this case, a surveying condition for this measurement may be estimated, and an estimated surveying result includes a content related to a linear movement of a surveying target that gradually descends. Under these conditions, matching between this estimated surveying result and actual surveying result is evaluated in step S112.

In the case in which the determination in step S112 results in NO, an error process is performed (step S113). When the error process is performed, a notification that a problem has arisen in execution of the automatic mode is provided to a user. For example, a notification signal is transmitted to a smartphone of a user, and receipt of this notification is displayed on the smartphone.

In the case in which the determination in step S112 results in YES, the contents in steps S108 to S111 are associated with each other and are stored as learning data (step S107). This learning data is used to perform supplementary learning for the AI-estimated model and to correct the AI-estimated model. The supplementary learning and the correction are performed at a certain time interval or each time a certain number of times of surveying is performed.

### Advantageous Effects

A surveying condition is estimated based on a photographic image of a surveying target and on environmental data of a surveying site. This reduces a burden on a worker in relation to setting of a surveying condition and enables automation or semi-automation of surveying operations.

In one example, for building primary roads and high-grade highways, similar surveying is repeated each day. In such a situation, an AI-estimated model for estimating a surveying condition is generated by using the learning data, in daily surveying. Specifically, in the initial stage of construction, a surveying condition is manually set in a surveying apparatus by a worker. As the operation progresses, the estimation accuracy of the AI-estimated model is improved, and automation of setting a surveying condition in the surveying apparatus tends to be completely performed. This reduces a burden on a worker and increases operation efficiency.

### 2. Second Embodiment

It is also possible to prepare multiple types of AI-estimated models. For example, the following models may be prepared: An “AI-estimated model for sunny weather” is generated by using learning data in the case of “Weather: sunny.” An “AI-estimated model for rainy weather” is generated by using learning data in the case of “Weather: rain.” An “AI-estimated model for snowy weather” is generated by using learning data in the case of “Weather: snow.” Then, the AI-estimated model for use is selected in accordance with actual weather conditions. Weather conditions can be acquired by a user or from weather information service on the Internet based on position information of an instrument point, or by another method.

### 3. Third Embodiment

It is also possible to set the AI learning unit 142 and the AI estimation unit 143 in a server that is connected to the Internet and to estimate a surveying condition by cloud processing.

### 4. Fourth Embodiment

Environmental data can be acquired by a method that uses a photographic image obtained by a camera. For example, the condition of a landform is photographed by a camera, and this photographic image is acquired as environmental data. In this case, a surveying target is not necessarily contained in the photographic image.

In one example in which a surveying site is set in an indoor place, it is effective to acquire environmental data by using a photographic image. Specifically, using a photographic image is appropriate for learning data of environmental conditions such as conditions in which interior finishing work is not performed, conditions in which interior finishing work is completed, or condition in which interior finishing work is underway, in the inside of a building. In addition, a residential room and a storage room for a warehouse can have different environmental conditions even though they are in the same building or even when they are in different buildings, and it is appropriate to use a photographic image in order to recognize this difference.

### 5. Fifth Embodiment

In this embodiment, an AI-estimated model is generated in advance based on learning data made by assuming that a target is a retroreflective plate and that the weather at a site is rainy. Of course, learning is performed beforehand with respect to cases of surveying other targets and to other weather conditions.

Under these conditions, surveying is actually performed in the state in which a target is a retroreflective plate and the weather is rainy. In this situation, the processing advances from step S101 to step S108 in FIG. 3. In step S108, a photographic image of the retroreflective plate is obtained. In addition, in step S109, data showing that the weather is rainy at the site is acquired.

Then, in step S110, a surveying condition is estimated by using the AI-estimated model described above. Due to the learning data that is made by assuming that a target is a retroreflective plate and that the weather at a site is rainy, a surveying condition appropriate for such a situation is estimated.

Specifically, an intensity of distance measuring light or a light reception condition (an attenuation amount of a light reduction filter), which is appropriate for a retroreflective plate and a rainy situation, is selected.

### 6. Sixth Embodiment

The following describes a case of performing a survey setting point determination operation using a reflection prism. In the survey setting point determination operation, a target device that is attached with a reflection prism at the top of a pole is used, and a worker supports or holds the target device in a standing state by hand and moves it in a surveying site. Under these conditions, the position of the reflection prism is measured by a total station, and a point of which the position is specified in a design drawing is determined on a ground surface of the surveying site. Then, a pile or an anchor bolt is driven at the determined point.

In this embodiment, it is assumed that a photographic image of the target device that is held by a worker is acquired as learning data in advance and that learning for an AI-estimated model is already performed by using this learning data. In addition, learning with respect to weather conditions is also already performed.

In this case, a photographic image of the target device in the state of being supported by a worker is obtained in the surveying site, and a surveying condition is estimated from the AI-estimated model, based on the photographic image and the environmental data.

As a result, on the basis of learning that is preliminarily performed, an emission condition or a light reception condition of distance measuring light appropriate for the survey setting point determination operation using the target device, is set, and the number of pulses and an interval of positioning appropriate for the survey setting point determination operation are estimated.

### 7. Seventh Embodiment

In this embodiment, an AI-estimated model is generated in advance based on learning data made by assuming that a target is a reflection prism disposed on a construction machine and that the weather at a site is sunny. Of course, learning is performed beforehand with respect to cases of surveying other targets and to other weather conditions.

Under these conditions, surveying is actually performed in the state in which a target is a reflection prism and the weather is sunny. In this situation, the processing advances from step S101 to step S108 in FIG. 3. In step S108, a photographic image of the construction machine on which the reflection prism is disposed is obtained. In addition, in step S109, data showing that the weather is sunny at the site is acquired.

Then, in step S110, a surveying condition is estimated by using the AI-estimated model described above. Due to the learning data that is made by assuming that a target is a reflection prism mounted on a construction machine and that the weather at a site is sunny, a surveying condition appropriate to such a situation is estimated.

Specifically, positioning is performed at an interval corresponding to a moving speed of the construction machine, and a surveying condition appropriate to a case of using a reflection prism as a target is estimated.

### 8. Eighth Embodiment

In this embodiment, an AI-estimated model is generated in advance based on learning data made by assuming that a target is a reflection prism disposed at a surveying site and that the weather at the site is sunny. Of course, learning is performed beforehand with respect to cases of surveying other targets and to other weather conditions.

Under these conditions, surveying is actually performed in the state in which a target is a reflection prism and the weather is sunny. In this situation, the processing advances from step S101 to step S108 in FIG. 3. In step S108, a photographic image of the reflection prism that is placed at the site is obtained. In addition, in step S109, data showing that the weather is sunny at the site is acquired.

Then, in step S110, a surveying condition is estimated by using the AI-estimated model described above. Due to the learning data that is made by assuming that a target is a reflection prism and that the weather at a site is sunny, a surveying condition that fits to such a situation is estimated. In this embodiment, the AI-estimated model can be used in searching for and automatically detecting the reflection prism in the photographic image. In step S110, the reflection prism is searched for and is automatically detected in the photographic image, and a surveying condition of the reflection prism is estimated.

In a surveying site, there may be cases in which setting up of a reflection prism and measurement of a position of the reflection prism by a total station are repeated. In such a situation, it would be convenient if the total station could automatically recognize and survey the reflection prism.

In this case, surveying is repeatedly performed on the same reflection prism in the same environmental conditions. Thus, mechanically learning this situation increases accuracy of automatic recognition of the reflection prism and, moreover, enables the surveying apparatus to autonomously set an automatic surveying condition. In other words, an AI-estimated model is constructed by customizing it in accordance with the site, and repetition of the surveying operation using the reflection prism as a target is automated.

### 9. Ninth Embodiment

It is also possible to acquire position information of a surveying apparatus from a surveying reference point. In this case, coordinates in the absolute coordinate system are provided to a surveying reference point to be surveyed, and a position and an attitude of a surveying apparatus are calculated from values of the coordinates by using a method of resection. Then, at least one piece of environmental data is acquired based on position information obtained from the surveying target. This method is effective in an environmental condition in which a GNSS is unavailable. Of course, a GNSS and this embodiment can be used together.

What is claimed is:

1. A surveying system comprising:
a surveying apparatus being configured to perform surveying;
a camera being configured to obtain a photographic image of a surveying target; and
a processor or circuitry being configured to:
acquire environmental data of a site at which the surveying is performed; and
store a surveying condition that is set in the surveying apparatus, the photographic image of the surveying target, which is obtained by the camera, and the environmental data, in association with each other.

2. The surveying system of claim 1, wherein the processor or circuitry is further configured to:
generate learning data by associating the surveying condition that is set in the surveying apparatus, the photographic image of the surveying target, which is obtained by the camera, and the environmental data, with each other; and
generate an AI-estimated model to be used for estimating a new surveying condition that is set in the surveying apparatus, based on a photographic image of the surveying target and environmental data that are newly obtained.

3. The surveying system of claim 1, wherein the processor or circuitry is further configured to:
generate learning data by associating the surveying condition that is set in the surveying apparatus, the photographic image of the surveying target, which is obtained by the camera, and the environmental data, with each other; and
have an AI-estimated model to be used for estimating a new surveying condition that is set in the surveying apparatus, based on a photographic image of the surveying target and environmental data that are newly obtained.

4. The surveying system of claim 1, wherein, in response to performing surveying by the surveying apparatus, the surveying condition that is set in the surveying apparatus, the photographic image of the surveying target, which is obtained by the camera, and the environmental data, are stored in association with each other.

5. The surveying system of claim 1, further comprising a GNSS position measurement device that is configured to perform surveying of a position based on a navigation signal from a GNSS navigation satellite,
at least one piece of the environmental data being acquired based on position information obtained in surveying by the GNSS position measurement device.

6. The surveying system of claim 1, wherein at least one piece of the environmental data is acquired based on position information obtained from the surveying target.

7. The surveying system of claim 1, further comprising a GNSS position measurement device that is configured to measure a position based on a navigation signal from a GNSS navigation satellite,
the environmental data containing data of weather at a site at which the surveying is performed,
the data of weather at the site at which the surveying is performed, being acquired from the Internet, based on information of the position measured by the GNSS position measurement device.

8. The surveying system of claim 1, wherein the processor or circuitry is further configured to estimate the surveying condition based on the environmental data,
appropriateness of the estimation is determined based on result of the surveying, and in a case in which the estimation is determined as being appropriate, the surveying condition that is set in the surveying apparatus, the photographic image of the surveying target, which is obtained by the camera, and the environmental data, are stored in association with each other.

9. A surveying method comprising:
performing surveying by using a surveying apparatus;
obtaining a photographic image of a surveying target;
acquiring environmental data of a site at which the surveying is performed; and
storing a surveying condition that is set in the surveying apparatus in performing the surveying, the obtained photographic image of the surveying target, and the environmental data, in association with each other.

10. A non-transitory computer recording medium storing computer executable instructions, the computer executable instructions being made to, when read and executed by a computer processor, cause the computer processor to:
make a surveying apparatus perform surveying;
obtain a photographic image of a surveying target;
acquire environmental data of a site at which the surveying is performed; and
store a surveying condition that is set in the surveying apparatus in performing the surveying, the obtained photographic image of the surveying target, and the environmental data, in association with each other.
